(19) United States
(12) Patent Application Publication
(10) Pub. No.: US 2014/0032222 A1
(43) Pub. Date: Jan. 30, 2014

(54) PATIENT SAFETY AND ALERT METHODS, DEVICES AND SYSTEMS

(71) Applicants: Sally J. VETTER, Tucson, AZ (US); Heather L. YOUNG, Menlo Park, CA (US); James W. VETTER, Portola Valley, CA (US)

(72) Inventors: Sally J. VETTER, Tucson, AZ (US); Heather L. YOUNG, Menlo Park, CA (US); James W. VETTER, Portola Valley, CA (US)

(73) Assignee: TransMed 7, LLC, Portola Valley, CA (US)

(21) Appl. No.: 13/597,541

(22) Filed: Aug. 29, 2012

Related U.S. Application Data
(62) Division of application No. 13/561,013, filed on Jul. 28, 2012.

(51) Int. Cl. G10L 11/00

(52) U.S. Cl. 704/274; 704/E11.001

(57) ABSTRACT

A medical error alert device may comprise a controller; a first memory, a recording and playback module and a user interface. The user interface may be configured to enable a patient or a patient representative to record an announcement identifying at least a medical procedure to be carried out. The user interface may be further configured to enable later playback of the announcement before the medical procedure is carried out. A communication device may be provided, coupled to a network to enable reception of signals from the network comprising at least predetermined patient identification number and/or a unique medical alert device identifier. A predetermined alert may be generated responsive to the communication device receiving a signal associated with the predetermined alert and the patient identification number and/or the unique device identifier.

### BACKGROUND

The present embodiments are in the medical device field. More particularly, the present embodiments relate to methods, devices and systems to ensure patient safety and to document the pairing of one individual patient and a single medical procedure.

Conventionally, the responsibility for ensuring that each patient undergoes the correct, intended procedure was shared amongst the various personnel having contact with the patient. Indeed, those having patient responsibility strive to keep all information gathered prior to the intended procedure close at hand, accurate, reliable and cross-checked with all available medical records. In theory, such a system makes sense, as it attempts to put multiple safety levels in place by spreading the responsibility among the several staff members of a facility. In practice, however, there are several stages where the system breaks down, generally unbeknownst to those responsible for patient safety and correctness of procedures. One relatively common source of frustration and errors stems from the reality that medical records are often incomplete, as such records are most often compiled by personnel who are often overworked, short on sleep, hurried, or called away during critical moments of the preparation and/or updating of such medical records. Patient safety may, therefore, be compromised, as those responsible for patient care and safety often do not resume and complete the documentation tasks that were interrupted.

Such potential patient safety problems mainly occur in a random fashion. However, a closer examination of the environment in which such procedures are carried out reveals built-in challenges to this shared responsibility model. Indeed, all hospitals and medical care facilities function subject to the vagaries of unexpected traffic peaks, emergencies and other disruptions to the daily routine. Though random, many of these disruptions often occur cyclically or in clusters. Even attempts at efficiencies can result in an increased incidence of wrong-procedure events. The consequences of such avoidable errors are readily apparent and extend beyond personal tragedy to large increases in the cost of care, many justifiable lawsuits, countless numbers of hours of recovery and many, usually unnecessary repeat operations (for example, to treat the correct side). Surprisingly, particularly for the lay person, such mistakes are not as difficult to make as one might initially assume, as diseases commonly affect both sides of roughly symmetrical anatomy. When a decision is carefully made to single out an organ, limb or structure for treatment and that particular organ, limb or structure is not treated, it is apparent that an additional procedure or surgery will need to be performed.

For many reasons, like-procedures are often clustered together for efficiency and scheduling purposes. For example, there are often “days” for many common procedures and physicians tend to try to group their procedures so that they can maximize use of their time in the operating and procedures rooms. An additional factor that may not be apparent theoretically, but one that becomes obvious in practice is that the very method designed to provide safety “layering”, i.e., spreading the responsibility among various levels of personnel, paradoxically often produces exactly the reverse of the desired effects. Indeed, instead of creating a multiply redundant system of checks and re-checks, in practice, many having patient responsibility incorrectly assume that someone else has already positively matched the patient and the procedure, often to considerable harm to the patient. Indeed, this problem is exacerbated by the current trend of fragmentation of routine tasks among the many individuals charged with providing patient care.

In prior years, a single person or a group of persons would accompany a patient from their room or pre-op area to the operating room. Such would often include an operating room nurse, anesthesiologist, nurse anesthetist or a nurse from the floor/room where the patient is already well known. The current trend, however, is for a different set of personnel to transport the patient to various places in hospitals, with the consequent potential for increased likelihood of a breakdown in the identification of the patient/procedure pairing. These and other circumstances lead to oversights, confusions and mix-ups, harm to the patient and costly litigation. For example, the wrong foot may be amputated or the wrong artery is bypassed, the right-side breast may be biopsied instead of the left-side breast, etc. In fact, there is evidence to support that despite best efforts, these types of avoidable errors remain unacceptably common. These same circumstances often contribute to medical errors such as, for example, incorrect medications being ordered, an incorrect dose of the right medication being ordered, a medication being ordered for a similarly-named patient, among other avoidable errors.

### BRIEF DESCRIPTION OF THE DRAWINGS

FIG. 1 is a diagram of a conventional hospital ID bracelet.

FIG. 2 is a diagram of a patient ID bracelet configured for coupling with a medical error alert device according to one embodiment.

FIG. 3 is a diagram of a medical error alert device, according to one embodiment.

FIG. 4 is a diagram of a medical error alert device, according to one embodiment.

FIG. 5 is a diagram of a medical error alert device, according to one embodiment.

FIG. 6 is a diagram of a system for reducing medical errors, according to one embodiment.

FIG. 7 is a diagram of one embodiment of a medical error alert device, in use on a patient.

FIG. 8 is a diagram of a system, according to one embodiment.

FIG. 9 is a diagram of an alert table, according to one embodiment.

FIG. 10 is a diagram of a medical error alert device, according to one embodiment.

FIG. 11 is a block diagram of some of the electronic and electromechanical functional components of a medical error alert device, according to one embodiment.

FIG. 12 is a flowchart of a method for reducing medical errors, according to one embodiment.

FIG. 13 is a flowchart of a method for reducing medical errors, according to one embodiment

### DETAILED DESCRIPTION

Conventionally, no single solution or methodology has been shown to repeatedly and reliably ensure that the right procedure is carried out on the right patient. At the time of the procedure, the patient may be unable to effectively advocate for him or herself, as the patient is often pre-medicated or already under anesthesia.

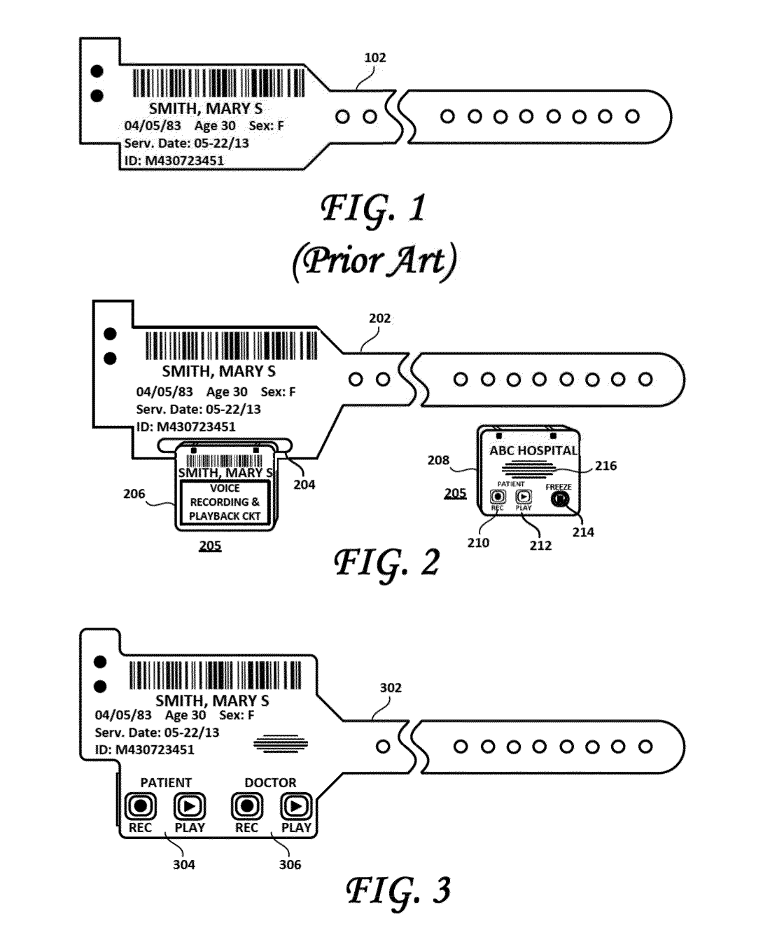

FIG. 1 is a diagram of a conventional hospital ID bracelet 102. As shown, the conventional hospital ID bracelet 102 may be attachable to the patient and may include a pre-printed sticker detailing, for example, the patient's name, date of birth, his or her patient identification number, age and sex. Such conventional hospital ID bracelets are worn by hospital patients and are not typically removed until the patient is discharged from the hospital. Medical services providers such as doctors and nurses check the bracelet 102 at various times to ensure that they are treating the correct patient. The use of such conventional hospital ID bracelets has decreased, but has far from eliminated, the incidence of medical errors.

FIG. 2 is a diagram of a patient. ID bracelet 202 configured for coupling with a medical error alert device 205 according to one embodiment. As shown, the patient ID bracelet 202 may define, according to one embodiment, a slot 204 in which a medical error alert device 205 according to one embodiment may be fitted, to couple the medical error alert device 205 to the patient ID bracelet 202. It is to be noted that the present medical error alert device 205 need not be coupled to a patient ID bracelet 202. According to one embodiment, the medical error alert device 205 may be coupled to an article of the patient's clothing, to the patient's chart, to the patient bed or to any other feature of the patient or the patient's room. For example, according to one embodiment, the alert device 205 may be coupled to a neonate's isolette. It is also to be noted that the physical shape of the alert device 205 shown in FIG. 2 is but one of many possible shapes. Indeed, the functionality of the alert device 105 may be shaped differently than shown herein and/or be integrated into or coupled to other commonly used devices such as a child's toy, for example.

Reference 206 of the medical error alert device 205 denotes one side of the medical error alert device 205 and reference 208 denotes the other side of the medical error alert device 205. As shown at 206, the medical error alert device 205 may comprise, for example, a machine-readable code such as a barcode and various patient information such as, for example, the patient's name and other information shown in FIG. 1. This patient information may be pre-printed on a sticker affixed to the medical error alert device 205. The patient identification number may be included in the pre-printed information and may also be encoded in the machine-readable code. The other side 208 of the medical error alert device 205 may comprise, according to one embodiment, a user interface. According to one embodiment, the user interface may comprise a button 210 for at least the patient to record a voice announcement. Herein, the term button comprises, within its scope any type of actuator enabling the user to interact with or select the current functionality of the present medical error alert device. By pressing the Record button 210, the patient may record a voice announcement prior to undergoing an intended procedure. For example, the patient may push the record button 210 and record his or her voice such as: “I am Mary Smith, my date of birth is Sep. 26, 1978 and I am here at ABC Hospital on Mar. 16, 2013 for a biopsy of my left breast”. According to one embodiment, such a medical error alert device 205 may also be configured for playback of the patient's recorded voice announcement through a small speaker 216, using the play button 212 of the alert device's user interface. The patient may play back his or her voice announcement and, when satisfied, press the freeze button 214 to disable any further changes to the recorded voice announcement. Such a recorded voice announcement may also be played back by medical services providers (e.g., doctors, nurses, transporters, etc.) at any time prior to the medical is procedure being carried out. Such is useful for the medical services providers to unequivocally ascertain the intended procedure When the patient may not be conscious or may otherwise be unable to speak, such as when intubated, for example. In the case in which the patient is not able to record such a voice announcement (such as may be the case in which the patient is too young, too old, to sick or unconscious), his or her care-taker or other trusted individual or entity (including the triage nurse, for example) may make and record the voice announcement. Such a medical error alert device may provide a secure, direct and reliable pairing of patient and procedure (Mary Smith, left breast biopsy), as well as a convenient, multiply repeatable way to audibly (and visually confirm, according to embodiments) confirm the correct procedure to be performed.

According to one embodiment, the device may be configured to enable the surgeon to record his or her own voice announcement to confirm the. correct patient/procedure pairing. For example, the surgeon may listen to the patient-recorded voice announcement and thereafter record his or her own confirmatory voice announcement in the operating room, immediately before carrying out the procedure. The surgeon's confirmatory voice announcement may take the form of, for example “Today is Mar. 16, 2013, and I am Dr. Marian Amadon and I am here today in OR 3 at ABC Hospital to perform a left Breast Biopsy on Mary Smith”. The surgeon may, for example, record his or her announcement on the same alert device 205, by pressing button 210 if the freeze button 214 has not been pressed of by pressing, for example, a predetermined sequence of buttons 210, 212, 214 to enable the surgeon to record his or her voice announcement immediately prior to carrying out the medical procedure. The surgeon may then freeze his of her voice announcement, thereby disallowing further Changes thereto. Should the patient-recorded voice announcement not match the procedure intended to be performed by the surgeon, the surgery may be canceled, at least until the issues surrounding the apparent contradiction are sorted out. For example, the patient may have recorded a voice announcement stating that a given procedure is to be carried out on her left foot, whereas the surgeon may have been under the impression that another procedure was to be carried out on the right foot. According to one embodiment, the announcer need not speak the date, as each recorded message may be automatically time-stamped. According to one embodiment, the voice announcement(s) may be stored internally within the medical error alert device 205 or even transmitted wirelessly to a network to be stored remotely. For example, the alert device 205 may comprise a first memory configured to store one or more voice announcements. Such a first memory may comprise a non-volatile memory such as, for example, a flash memory. According to another embodiment, the first memory may comprise a Write Once Read Many (WORM) memory that does not allow changes to be made to a recording, once made. In fact, for disambiguation purposes, all voice announcements may be stored consecutively, even before the freeze button (or functional equivalent) 214 is pressed. If needed, all such recordings may be played back if needed for risk management or litigation purposes, for example.

FIG. 3 is a diagram of a medical error alert device 302, according to one embodiment. As shown therein, many of the features and functionality of the alert device 205 are integrated into the medical error alert device 302. In FIG. 3, the medical error alert device 302 and its functionality is integrated into a patient ID bracelet that may be securely affixed to a patient. The medical error alert device 302 may comprise a user interface comprising, for example, separate record and play buttons for the patient and doctor or other medical services provider, as shown at 304 and 306. Even though separate controls are provided for the doctor, a specific sequence of key presses may be required to access the functionality of such buttons. Such would prevent the patient from recording a voice announcement in place of the doctor. Alternatively, the functionality of the user interface buttons 306 reserved for doctor's use may be disabled until the medical error alert device 302 is in close proximity to the doctor, who may be provided with a complementary device configured to communicate with the medical error alert device 302. Known technologies may be used to implement such functionality such as, for example, Near Field Communication (NFC), Radio Frequency Identification (RFID), and the like.

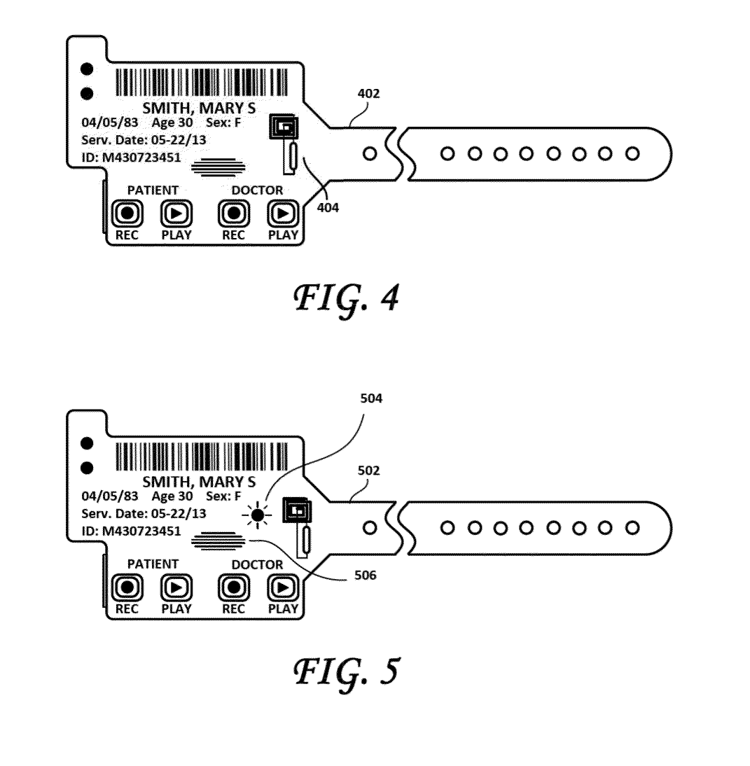

FIG. 4 is a diagram of a medical error alert device 402, according to one embodiment. As shown therein, the medical alert device 402 may be uniquely identified through some medical alert device identifier (e.g., a unique number, code or string) that is different from all other medical alert devices in use. The medical alert device 402 may also be configured to store, in a non-volatile memory for example, the patient's own patient identification number. According to one embodiment, the medical alert device identifier and the patient identification number may be identical or otherwise complementary. The medical alert device 404 may be configured to provide either or both the medical alert device identifier and the patient identification number when scanned, polled or asynchronously upon, for example, occurrence of a predetermined event. In FIG. 4, reference 404 denotes an RFID or other short or longer range communication device, which may be either passive (smaller range, less expensive) or active (greater range, more costly). The communication device (for example, RFID) 404, according to one embodiment, may be configured to respond, when interrogated by a network, at least with the patient identification number, the medical alert device identifier and/or any other identifier that may be unique to the patient and/or the medical error alert device itself. However, present medical alert device 402 is not limited to the use of RFID to communicate with the outside world. For example, 404 may denote the antenna to enable a controller within the medical alert device 402 to couple to a network such as a WiFi network, some proprietary network or the Internet, for example. Toward that end, the controller within the medical alert device 402 may be coupled to a communication device having functionality enabling it to function as a full-fledged, uniquely identified and addressable node on a, for example, TCP/IP network. According to one embodiment, the medical alert device may comprise a communication device coupled to the controller. According to one embodiment, the communication device may be configured to couple to a network, to receive signals from the network and to provide the network at least with the predetermined patient identification number of the patient and/or the medical alert device identifier.

FIG. 5 is a diagram of a medical error alert device 502, according to one embodiment. As shown therein, the user interface of the medical alert device 502 may comprise an audio indicator 506 (such as a speaker or other e.g., PZT-based, noise-generating device). The medical alert device 502 may also include a visual indicator 504, implemented in FIG. 5 as a blinking or steady light. Both the audio and visual indicators 506, 504 may be coupled to and controlled by the controller within the medical alert device 502. According to one embodiment, the combination of audio and visual indicators 506, 504, coupled with the ability of the communication device of the medical alert device 502 to provide a medical alert device identifier and/or a patient identification number to the outside world (e.g., to a remote device or network) opens up a world of functionality not previously available to patients and medical service providers, to reduce the incidence of medical errors, as detailed below.

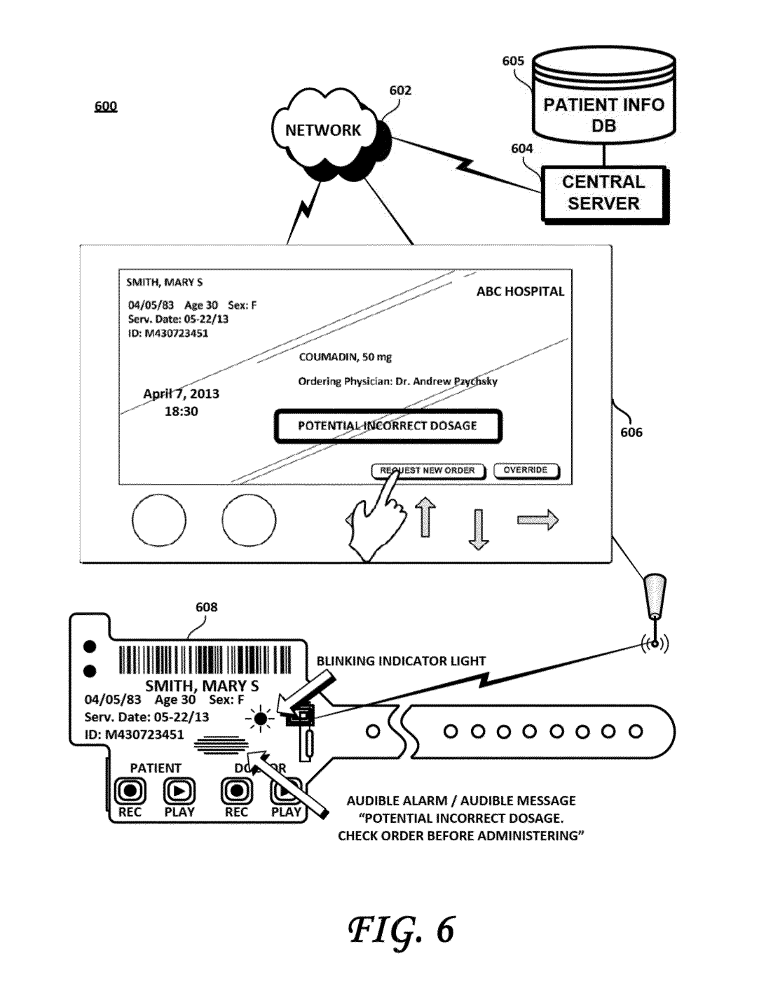

FIG. 6 is a diagram of a system 600 for reducing medical errors, according to one embodiment. As shown therein, the system 600 may be configured to operate within and connect to a network 602. A central server 604 may be coupled to the network 602, as may be a database of patient information, as shown at 605. A computing device 606, such as a rack-mounted mobile computer system configured to be pushed into a patient's room may also be configured to couple to the network 602. The computing device 606 may also be a mobile device such as, for example, a tablet computer or a mobile phone. For example, the computing device 606 may be configured with a capacitive or resistive touch sensitive display, for example. Finally, System 600 may comprise a plurality of medical alert devices, such as shown at 608 in FIG. 6. To illustrate exemplary functionalities of the present medical alert device 608 in a system such as shown at 600, it is useful to describe a possible scenario in which the medical alert device 608 is instrumental in avoiding a potential medical error such as administering a wrong dosage of a potentially harmful medication.

Suppose that the doctor had mistakenly written orders for 50 mg of a medication such as Coumadin (Warfarin). Although such a dosage may be appropriate for very large patients, it nevertheless could prove harmful to a smaller patient. Assume also that the correct dosage of Coumadin for this patient was not 50 mg, but 5 mg. The order, therefore, incorrectly specified a dosage an order of magnitude larger than intended. Such an order may be entered in the patient's electronic chart. The patient's chart, moreover, may be maintained in the patient information database 605. Updating the patient's chart, therefore, may have caused a record within the patient information database 605 to have been updated with the new order for 50 mg of Coumadin. A routine within the central server 604 coupled to the patient information database 605 may read this updated record, and discover the potential incorrect dosage in the new order and flag the order as potentially specifying an incorrect dosage. The central server may then issue a signal through the network 602. The signal may, for example, be configured to comprise, encode or otherwise reference the patient identification number and/or the unique medical alert device identifier. The medical alert device 608, upon receiving the signal generated by the central server 604, and verifying that the received signal is intended for this medical error alert device 608 and this patient, may be configured to generate an audio and/or visual alert (or other human-perceptible alert such as a vibration). A nurse of a doctor, upon approaching the patient (for the purpose of administering the 50 mg of Coumadin or for any other purpose) will see and/or hear the alert generated by the medical error alert device 608, which alert will prompt the nurse or doctor to investigate the source of the alert before further treating the patient. For example, using the computing device 606 and the patient identification number, the computing device may be configured to retrieve the appropriate warning and display the same for the nurse or doctor. In this instance, the computing device 606 may be configured to display a potential incorrect dosage message, the patient information and the ordering physician, for example. The nurse may then request a new order or override the warning, among other possible actions, as appropriate for the circumstances. In this example, the nurse may not even have known of the existence of the order and may have entered the patient's room for an altogether different purpose. However, the audio and/or visual alerts generated by the medical error alert device 608 coupled to the patient provided just enough information to cause the nurse to investigate and find the reason behind the generation of the alert. According to one embodiment, the visual indicator may comprise, for example, a blinking indicator light and the audio indicator may comprise a more intrusive or insistent buzzer or beeping noise generator. That the audio and/or visual indicators were activated may be time-stamped and logged in the medical error alert device's non-volatile memory.

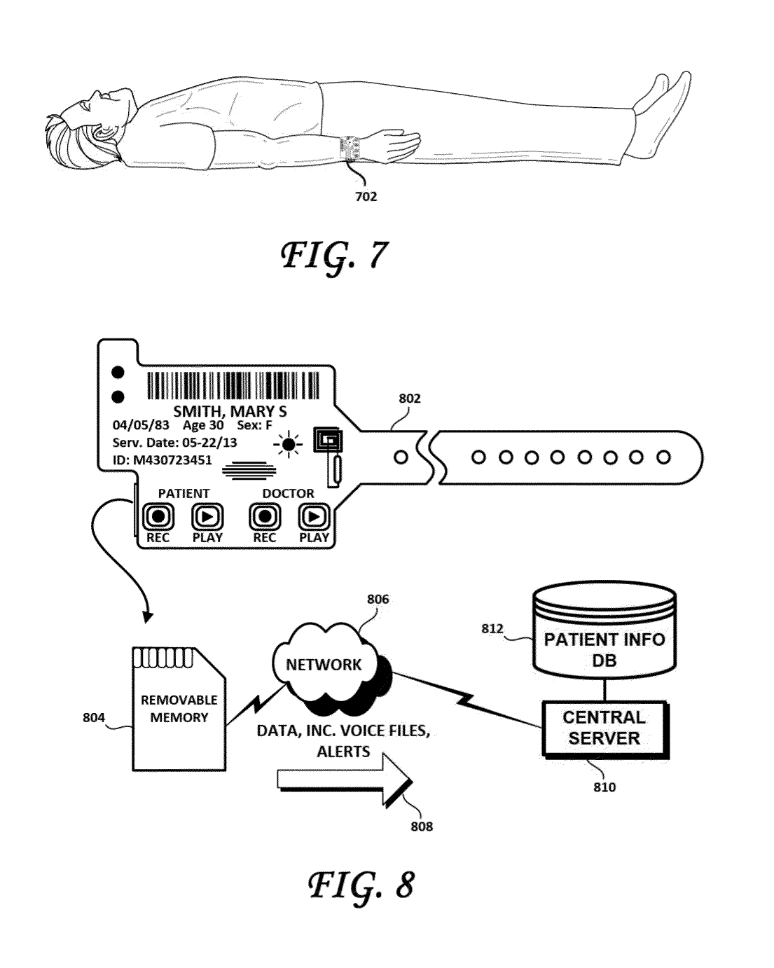

FIG. 7 is a diagram of one embodiment of a medical error alert device 702, in use on a patient. It is, of course, to be understood that the present medical error alert device 702 need not be in the form of a patient identification bracelet and may be affixed or coupled anywhere on or near a patient.

FIG. 8 is a diagram of a system, according to one embodiment. As shown therein, the memory 804 on which the time-stamped voice announcements and/or alerts are stored may be configured to be removable. Alternatively, the time-stamped voice announcements and/or alerts stored in memory of the medical error alert device 802 may be configured to be extracted through an I/O interface provided on the medical error alert device 802, thereby enabling the time-stamped voice announcements and/or alerts to be sent to the central server 810 for remote storage such as in the patient information database 812. The option to provide removable storage may be too costly, however, for a one-time use, disposable device such as the medical error alert device 802. Alternatively still the communication device within the medical error alert device 802 may enable the time-stamped voice announcements and/or alerts to be extracted wirelessly as shown at 808 through the network 806 for storage in, for example, the patient information database 812.

According to one embodiment, the medical error alert device 802 may be configured to generate an alert whenever a signal is received matching its medical alert device identifier and/or the patient identification number stored therein. In this case, the alert generation may be considered to be binary in nature; namely, either on or off. No information other than the mere existence of some unspecified alert is conveyed using a blinking light or a beeping audio indicator. The frequency of the blinking lights and beeping could be modulated to convey information, although such is not believed to be practicable in a hospital environment. However, adding a little more complexity to the signal sent to the present medical error alert device and modestly increasing the structure and functionality of the medical error alert device yields dividends in terms of communicating the nature of the alert to the medical care providers.

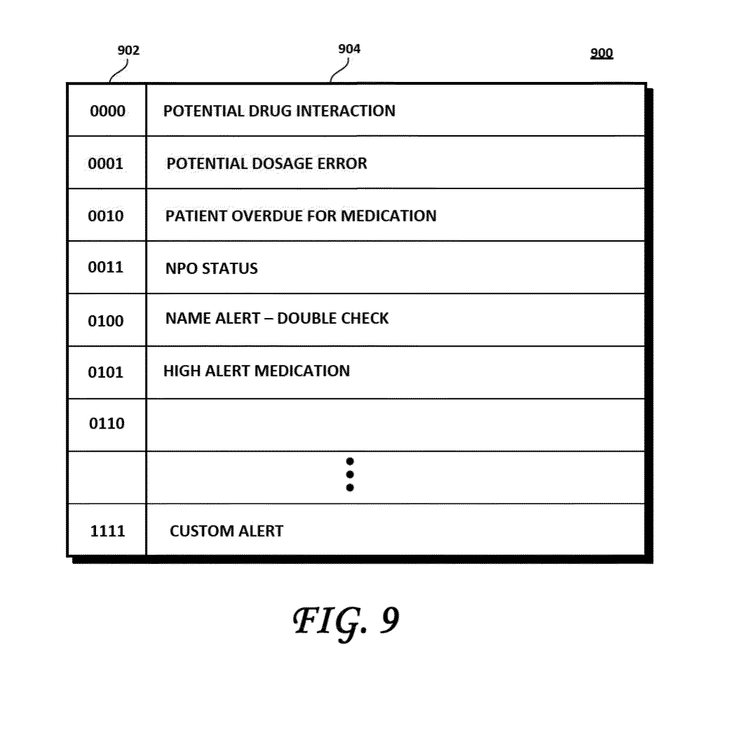

FIG. 9 is a diagram of an alert table 900, according to one embodiment. The alert table 900 may be stored within the present medical error alert device and within the central server, for example. Indeed, such an alert table 900 may be stored within the medical error alert device and accessed upon receipt of a signal from the network. Each record of the alert table 900 may correspond to a specific alert. Some of the alerts may correspond to sentinel. events while others may correspond to somewhat less serious potential medical errors. Examples of sentinel events include, for example, an adverse drug event, improper blood transfusion, surgical injury, wrong-site surgery, patient suicide, restraint-related injury or death, patient fall, burn, abduction, elopement or mistaken patient identity, to name but a few. The alerts 904 in the table 900 may be selected and the table 900 addressed using, for example, a simple 4-bit index, enabling any of 16 different alerts to be selected. One or more records of the alert table 900 may be reserved for custom alerts. Using a greater number of bits 902 (which may be collectively characterized as an alert code) allows for the storage and indexing of a greater number of alerts 904, as those of skill in this art will recognize. For example and according to one embodiment, if the signal to and received by the present medical error alert device were to be configured to comprise, encode or otherwise reference alert 0010, a stored voice file corresponding to the alert indexed at 0010 in the alert table 900 may be accessed and played through the speaker of the medical error alert device to announce, in an audible manner “Patient overdue for medication”. Some alerts may be configured to generate alerts that are more persistent and intrusive (e.g., loud spoken word alert) than others (e.g., blinking light). The alert field 904 may, in practice, contain an address in memory where the voice and/or other media (e.g., still, video or mixed media) file is stored corresponding to the alert code 902. To generate such a warning, the alert code 902 would provide an index into the alert table 900 whereupon the address contained in the alert field 904 would be accessed, read and retrieved, decoded and used to drive the device's speaker.

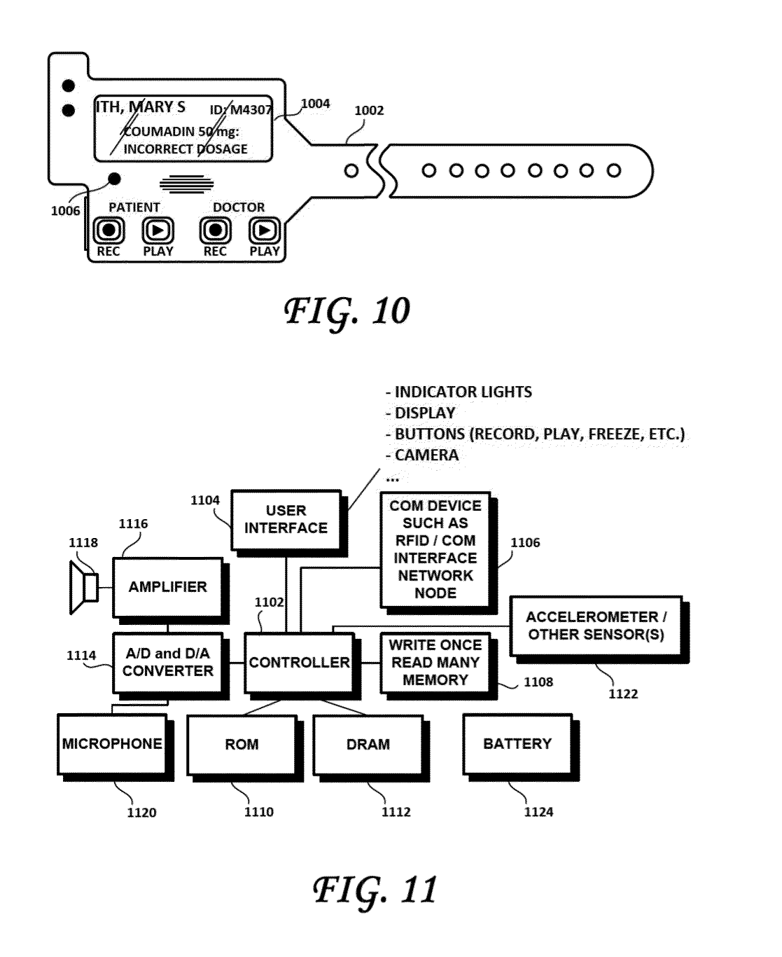

Alternatively still and according to one embodiment, the medical error alert device 1002 may comprise a display as shown at 1004 in FIG. 10. For example, the display 1004 may be configured to be rugged and flexible, such as a flexible Active-Matrix Organic Light-Emitting Diode (AMOLED) display, for example. Such small-size flexible displays 1004 are anticipated to become sufficiently affordable so as to make their inclusion in a one-time use, disposable medical error alert device not unreasonable or cost-prohibitive. Further, use of a display 1004 enables not only patient information to be displayed (e.g., scrolled) thereon, but also a clear, plain language, written statement of the alert. Such a display 1004 may also find uses other than the display of patient information and alerts. According to one embodiment, the medical error device 1002 may comprise a camera 1006. The camera 1006 being configured to enable the medical error device 1002 to take still photographs or videos. For example, the patient may record a video announcement of him or herself, detailing the procedure to be carried out and/or any other information. The recorded still photograph or video may then be played back at will on the display 1004. Moreover, the patient may use the camera 1006 to directly record and reference the site of the intended medical procedure. For example, the patient may take a picture or video of his or her left wrist that is to be operated upon. Such photographic. audio and/or video recording of the patient may later be archived by the hospital or other medical service provider for risk-management purposes, for example.

FIG. 11 is a block diagram of some of the electronic and electromechanical functional components of a medical error alert device, according to one embodiment. As shown therein, the present medical error alert device, according to one embodiment, may comprise a controller 1102. Many different controllers exist for such purpose, including, for example the low power Atmel AVR line of microcontrollers available from www.atmel.com. The controller 1102 may be suitably programmed to carry out the functionality described and shown herein, in combination with the other structures shown in FIG. 11. The controller may be coupled to the user interface 1104. The user interface 1104 may be coupled to and/or comprise indicator lights, buttons, displays, speakers and/or any other manner in Which the present medical error alert device interacts with the patient, doctor or any other user thereof. A communication device 1106 may also be coupled to the controller 1102. The communication device 1106 may comprise any structure and functionality that enables the present medical error alert device to communicate with one or more networks or other electronic devices. For example, the communication device 1106 may comprise, for example, RFID, a network interface card (NIC), NFC capability and/or any other short range or longer range communication technology. For example, the communication device 1106 may enable the present medical error alert device to identify itself as a fully qualified and uniquely identified node on a network. The communication device 1106 may be configured to receive signals from, for example, a server and to send signals over the network. For example, the communication device 1106 may be configured to receive one or more signals referencing the medical error alert device identifier and/or the patient identification number, together with other payload information, such as an alert code, for example. Such signals may be received by the communication device, decoded by the controller 1102 and acted upon as described herein to generate, for example, various alerts. The controller 1102 and the communication device 1106, according to one embodiment, may be configured to send the patient's and/or doctor's voice announcements across the network for remote storage, for example. Compression and encryption may be utilized to reduce bandwidth requirements and to safeguard patient information. For example, the encryption key used for encrypting patient information may be related to the patient identification number, among other possibilities.

Memory 1108 may be a WORM memory and may be configured to safeguard the patient and/or doctor voice announcements, to prevent tampering and post-facto changes to the announcements. Other technologies may be used, as appropriate. In place of a WORM memory 1108 or other similar technologies, the controller 1102 may be configured to disallow further changes to the voice announcements after the freeze button (or “Make It Official” button) has been pressed. Also coupled to the controller 1102 may be a Read Only Memory (ROM) 1110, which may store, for example, the firmware for the controller 1102. The ROM may also, for example, store the alert table 900, if such is not configured for storing customized alerts. If the alert table 900 is to be configured to accept user-defined entries, then the table 900 may be stored in some other non-volatile memory coupled to the controller 900. A Dynamic Random Access Memory (DRAM) 1112 may be provided for the controller 1102 to use as temporary storage during operation thereof. A digital to analog and analog to digital converter 1114 may also be coupled to the controller 1102, to convert the digital signal output from the controller 1102, convert it into analog form for output to an amplifier 1116, which drives speaker 1118. In this manner, voice and audio files (e.g., voice announcements from the patient and/or doctor and/or audio alerts) may be rendered by the speaker 1118, for the patient's, the doctor's or other medical services provider's ears. A microphone 1120 may be provided to pick up the patient's or the doctor's voice announcements, for example. According to one embodiment, at least the controller 1102, the A/D and D/A converter 1114, the microphone 1120, the amplifier 1116, the camera 1006 and the speaker 1118 may form a recording and playback module that may be configured to record and playback announcements and/or other messages, media or signals. The analog signal output from the microphone may be digitized in converter 1114 and provided to the controller 1102 for storage in, for example, memory 1108 and/or for broadcasting through the communication device 1106 over the network. In the same mauler, a still photograph and/or video content may be stored and/or broadcast over the network.

As microelectromechanical systems (MEMs) become more prevalent and cost effective, an array of inexpensive sensors 1122 may be incorporated into the present medical error alert device. One such sensor is an accelerometer, as shown at 1122. Inclusion of an accelerometer in the present medical error alert device may enable a number of functionalities. For example, an alert may be generated (either locally on the medical error alert device or remotely on a client computing device accessing a central server of a network), if the accelerometer does not detect motion on the patient's part for a predetermined period of time. Conversely, the accelerometer 1122 may also be used to detect a fall, such as if the patient falls in the bathroom. Upon detection of a rapid acceleration and increased g forces characteristic of a slip and fall, the controller 1102 may be configured to cause the communication device 1106 to send a signal indicative of the slip and fall to a remote server, which may alert the nurse's station, for example. Other possibilities, including geo-locating a patient within a care facility, may be devised, in combination with, for example, an RFID tag and the communication device 1106. A battery 1124 may provide all necessary power to the device. The battery may be sealed, non-rechargeable or may be configured to be recharged, such as may be required, for example, for extended hospital stays. Non-contact battery recharging methods and technologies are well known and may be used here to good advantage. The constituent elements of the medical error alert device shown in FIG. 11, together with other ancillary circuitry, may be provided as discrete elements or hilly or partially integrated into a System on Chip or SoC. Such a SOC may contain digital, analog, mixed-signal, and radio-frequency functions, all on a single chip substrate.

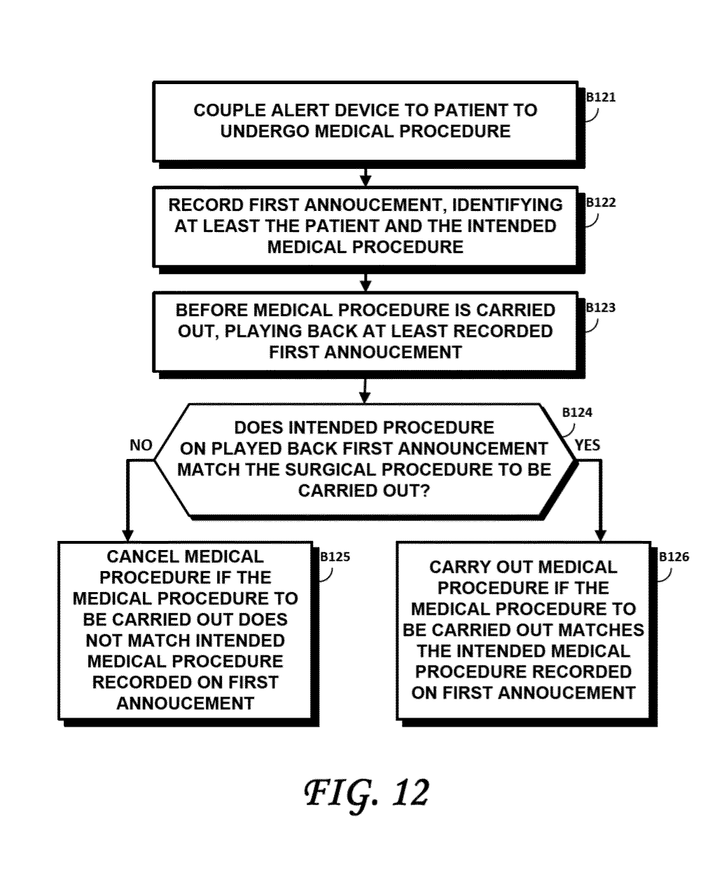

FIG. 12 is a flowchart of a method for reducing medical errors, according to one embodiment. As shown therein, block B121 calls for coupling a medical error alert device to a patient to undergo a medical procedure. According to one embodiment, the medical error alert device may comprise at least a controller, a first memory coupled to the controller, a record and playback module and a user interface. The user interface may be configured to enable at least the patient to record a first announcement. The first announcement may comprise voice, photograph or video data. Block 122 calls for recording the first voice announcement on the medical error alert device. The first announcement may identify, for example, at least the patient and the intended medical procedure to be performed on the patient. As shown at B123, before the medical procedure is to be carried out, the recorded first announcement may be played back from the medical error alert device. Decision box B124 calls for determining whether the intended procedure played back on the first announcement matches the surgical procedure the surgeon intends to carry out on the patient. If the intended procedure played back on the first announcement matches the surgical procedure the surgeon intends to carry out on the patient (YES branch of B124). the procedure may be carried out on the patient, with increased confidence that the correct procedure is, in fact, being carried out. If however, the intended procedure played back on the first announcement does not match the surgical procedure the surgeon intends to carry out on the patient (NO branch of B124), the procedure should be canceled or at least delayed until the source of the apparent mismatch is identified and the correct surgical procedure is identified.

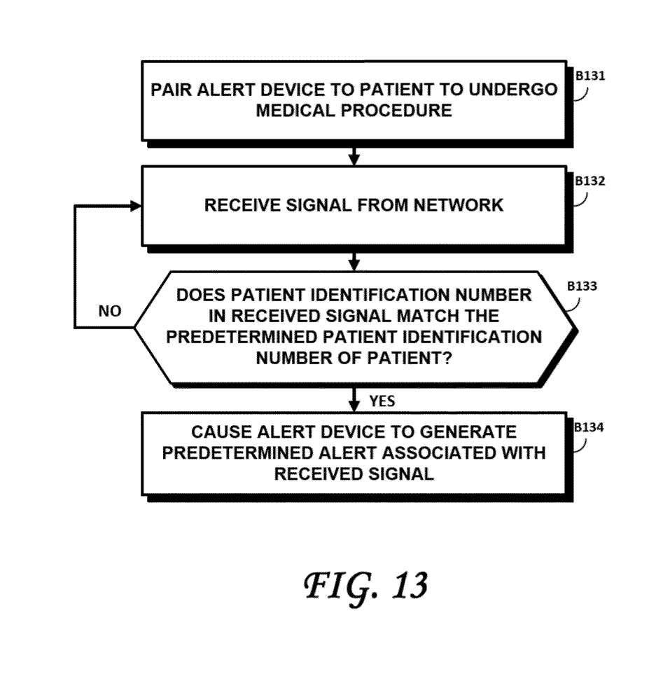

FIG. 13 is a flowchart of a method for reducing medical errors, according to one embodiment. As shown at Block B131, the medical error alert device may be paired to the patient to undergo a medical procedure. The medical error alert device to one embodiment, may comprise a controller, a first memory coupled to the controller, an audio and/or visual alert device and a communication device coupled to the controller. The communication device may be configured to couple to a network, to receive signals from the network and to provide the network at least with a predetermined patient identification number unique to the patient. According to one embodiment, pairing the alert device to the patient may comprise, for example, at least storing the predetermined patient identification number in the alert device. As shown at B132, the alert device may then receive a signal from the network, through the communication device, for example. The received signal may be intended for this or another alert device and may pertain to this or another patient. The signal received from the network may be associated with one of a plurality of predetermined alerts and may comprise, for example, a patient identification number and/or a medical error alert device identifier. For example, the received signal may comprise an alert code identifying one of a plurality of possible alerts and may comprise, encode or otherwise reference the patient identification number and/or a medical error alert device identifier, thereby enabling customized point-to-point communication between an alert transmitter such as a central server and a particular alert receiver, such as the medical error alert device according to one embodiment. At decision box B133, it may be determined whether the signal is intended for this particular patient and/or this particular medical error alert device (which may be one and the same destination). According to one embodiment, it may be determined whether the patient identification number (and/or the medical error alert device identifier) matches the patient's own patient identification number or the medical error alert device identifier of the medical error alert device coupled to the patient. If not (NO branch of B133), the received message is not intended for this patient/medical error alert device and the method may revert back to Block B132. If, however, the patient identification number (and/or the medical error alert device identifier) matches the patient's own patient identification number or the medical error alert device identifier of the medical error alert device coupled to the patient, then the controller may cause the alert device to generate (using, for example, sound, a visual indicator, text, vibrations, etc.) the alert specified by, e.g., the alert code embedded in the received signal, as shown at Block B134.

Advantageously, embodiments provide a medical safety device that may be configured as a reliable and tamper-resistant information-access device. The device may be configured to function as a durable and reliable record that may be accessed pre-operatively, intra-operatively and post-operatively and may advantageously function as a lifesaving, morbidity sparing, cost saving and liability limiting device. The present medical error alert device may be relied on as an unalterable voice record of the intent of the patient and of the surgeon, enabling all personnel involved with patient care the ability to cross-check the correct pairing of the procedure and the patient. One embodiment of the device may be configured for single-use, single calendar date, single patient, single intended operation, such that the probability of carrying out the wrong procedure on the right patient or carrying out the right procedure on the wrong patient should be drastically reduced. According to one embodiment, the present device may complement or duplicate at least a portion of other record-keeping modalities, such as the patient's medical chart, clipboard or other source of information. In so doing, the present devices and systems greatly extend the functionality of conventional identifying devices already in use, such as the single use, non-re-attachable passive hospital ID bracelets that are in common usage in most medical facilities. The functionality of the present devices and systems extends well beyond the functionality of such passive conventional devices, and combines positive identification and alerts with critical pieces of information that are needed to ensure that the correct procedure is being performed on the correct patient and that alerts are properly received at the bedside where the care is delivered and potential errors are made. One embodiment may drastically increase the probability of the practitioner operating on the correct limb or the correct organ, particularly where there are multiple or at least bilateral candidate organs for a given procedure (bypassing the incorrect coronary artery is not unfortunately as rare as is commonly believed, for example).

While certain embodiments of the inventions have been described, these embodiments have been presented by way of example only, and are not intended to limit the scope of the inventions. Indeed, the novel methods, devices and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, those skilled in the art will appreciate that in various embodiments, the actual structures (such as, for example, the precise nature of the communication device, controller and memories) may differ from those shown in the figures. Depending on the embodiment, certain of the steps and/or devices, structures or modules described herein above may be removed, others may be added. Also, the features and attributes of the specific embodiments disclosed above may be combined in different ways to form additional embodiments, all of which fall within the scope of the present disclosure. For example, one embodiment may include the is announcement (e.g., voice, still photograph, video or mixed media) functionalities described and shown herein and none or few of the alert functionalities also described and shown herein. Conversely, other embodiments may omit some or all of the announcement functionalities in favor of the network-enabled alert functionalities shown and described herein according to need and available budget. That is, the functionalities and structures shown and described herein may be effectively mixed and matched according to the needs at hand and the cost of the device. For example, some of the structures of the present medical error alert device may be configured to be sterilizable and re-usable or the entire device may be configured for one-time, disposable use. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1-27. (canceled)

28. A medical alert patient identification (ID) device, comprising:
a controller;
a first memory coupled to the controller;
a communication device coupled to the controller, the communication device being configured to couple to a network and to receive signals from the network and to provide the network at least with a predetermined patient identification number;
an alert device coupled to the controller, the controller being configured to cause the alert device to generate a predetermined alert responsive to the communication device receiving a signal associated with the predetermined alert and the patient identification number.

29. The medical alert patient ID device of claim 28, wherein the alert device comprises a visual alert indicator, wherein the predetermined alert comprises a visual alert and wherein the controller is further configured to cause the visual alert indicator to generate the visual alert.

30. The medical alert patient ID device of claim 28, wherein the communication device is uniquely identified on the network.

31. The medical alert patient ID device of claim 28, wherein the communication device comprises a Radio Frequency Identification Device (RFD) and wherein the RFID is configured to respond, when interrogated by the network, with at least one of the patient identification number and a unique identifier of the patient ID device.

32. The medical alert patient ID device of claim 28, wherein the communication device is configured to comply with a packetized network protocol and to function as a uniquely-identified node on the network.

33. The medical alert patient ID device of claim 28, wherein the alert device comprises an audio alert generator, wherein the predetermined alert comprises an audio alert and wherein the controller is further configured to cause the audio alert generator to generate the audio alert.

34. The medical alert patient ID device of claim 28, wherein the communication device is configured to receive a first signal or a second signal from the network, and wherein the controller is further configured to cause the alert device to generate a first predetermined alert responsive to the communication device receiving the first signal and to generate a second predetermined alert responsive to the communication device receiving the second signal.

35. The medical alert patient ID device of claim 28, further comprising a flexible display coupled to the controller, the flexible display being configured to display at least one of patient identification information, a unique identifier of the patient ID device and alerts.

36. The medical alert patient ID device of claim 28, further comprising:
a recording and playback module coupled to the first memory;
a user interface coupled to the recording and playback module, the user interface being configured to enable a patient or patient representative to record, on the first memory, a first announcement identifying at least a medical procedure to be carried out on the patient, the user interface being further configured to enable later playback of the first announcement before the medical procedure is carried out.

37. The medical alert patient ID device of claim 36, wherein the user interface is further configured to enable a medical services provider to record, on the first memory, a second announcement identifying the medical procedure to be carried out on the patient, wherein the user interface is configured to enable consecutive playback of the first and second announcements for comparison before the medical procedure is carried out.

38. The medical alert patient ID device of claim 28, wherein the patient device is integrated into a patient identification (ID) wristband.

39. The medical alert patient ID device of claim 36, wherein at least the controller, the first memory, the recording and playback module and the user interface are integrated into a device configured to couple to a patient identification (ID) wristband.

40. The medical alert patient ID device of claim 28, configured to accompany the patient to an operating room.

41. The medical alert patient device of claim 28, wherein the first memory is a non-volatile memory.

42. The medical alert patient ID device of claim 28, wherein the first memory is a Write Once Read Many (WORM) memory.

43. The medical alert patient ID device of claim 36, wherein the user interface is further configured to enable a disablement of changes to the first announcement.

44. The medical alert patient ID device of claim 37, wherein the user interface is further configured to enable a disablement of changes to the second announcement.

45. The medical alert patient ID device of claim 28, wherein the controller is further configured to time-stamp the predetermined alert and wherein the controller is further configured to cause the time-stamped predetermined alert to be stored in the first memory.

46. The medical alert patient ID device of claim 45, wherein the controller is further configured to enable extraction of at least the time-stamped predetermined alert from the first memory, to enable storage thereof remote from the patient ID device.

47. The medical alert patient ID device of claim 37, further configured to enable extraction of the first and second recorded announcements in digital form and storage thereof remote from the patient ID device.

48. The medical alert patient ID device of claim 28, wherein the first memory is removable.

49. A method to reduce medical errors, comprising;
pairing an alert device to a patient to undergo a medical procedure, the alert device comprising a controller, a first memory coupled to the controller, an alert device and a communication device coupled to the controller, the communication device being configured to couple to a network and to receive signals from the network and to provide the network with at least one of a predetermined patient identification number unique to the patient and an alert device identifier unique to the alert device;
receiving a signal from the network, the received signal being associated with one of a plurality of predetermined alerts and comprising at least one of a patient identification number and an alert device identifier;
causing the alert device to generate the predetermined alert associated with the received signal when at least one of:
the patient identification number in the received signal matches the predetermined patient identification number unique to the patient, and
the alert device identifier in the received signal matches the alert device identifier of the alert device paired to the patient.

50. The method of claim 49, wherein the alert device comprises visual alert indicator, and wherein the method further comprises causing the alert device to generate a visual alert.

51. The method of claim 49, wherein the communication device comprises a Radio Frequency Identification Device (RFID) and wherein the method further comprises the RFID responding, when interrogated by the network, with at least one of the patient identification number and the alert device identifier.

52. The method of claim 49, wherein the communication device is configured to comply with a packetized network protocol and to function as a uniquely-identified node on the network.

53. The method of claim 49, wherein the alert device comprises an audio alert generator, wherein the method further comprises causing the audio alert generator to generate an audio alert.

54. The method of claim 49, further comprising the communication device receiving a first signal or a second signal from the network, and causing the alert device to generate a first predetermined alert responsive to the communication device receiving the first signal and causing the alert device to generate a second predetermined alert responsive to the communication device receiving the second signal.

55. The method of claim 49, wherein the alert device further comprises a flexible display coupled to the controller, and wherein the method further comprises displaying at least patient identification information and alerts on the flexible display.

56. The method of claim 49, wherein the alert device further comprises a user interface coupled to the first memory and a recording and playback module coupled to the user interface, and wherein the method further comprises:
through interaction with the user interface, enabling a patient or patient representative to record, on the first memory, a first announcement identifying at least a medical procedure to be carried out on the patient, and to subsequently play back the first announcement before the medical procedure is carried out.

57. The method of claim 56, wherein the method further comprises:
through the user interface, enabling a medical services provider to record, on the first memory, a second announcement identifying the medical procedure to be carried out on the patient, and subsequently enabling consecutive play back of the first and second announcements for comparison before the medical procedure is carried out.

58. The method of claim 49, wherein the alert device is integrated into a patient identification (ID) wristband.

59. The method of claim 49, wherein the first memory is a non-volatile memory.

60. The method of claim 49, wherein the first memory is a Write Once Read Many (WORM) memory.

61. The method of claim 57, further comprising disabling changes to the first announcement.

62. The method of claim 58, further comprising disabling changes to the second announcement.

63. The method of claim 49, further comprising:
time-stamping the predetermined alert, and
storing the time-stamped predetermined alert in the first memory.

64. The method of claim 64, further comprising enabling extraction of at least the time-stamped predetermined alert from the first memory.

65. The method of claim 58, further comprising
extracting the first and second recorded announcements in digital form; and
storing the extracted first and second recorded announcements remote from the alert device.

66. The method of claim 49, wherein the first memory is removable and wherein the method further comprises removing the first memory from the alert device.

67. The method of claim 49, wherein pairing the alert device to the patient comprises at least storing the predetermined patient identification number in the alert device.
